(19) United States
(12) Patent Application Publication
(10) Pub. No.: US 2006/0150498 A1
(43) Pub. Date: Jul. 13, 2006

(54) Airtight container for culturing flowers

(76) Inventor: Chen-Che Chen, Chia I Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/017,937

(22) Filed: Dec. 22, 2004

(51) Int. Cl. A01G 9/02

(52) U.S. Cl. 47/65.5

(57) ABSTRACT

An airtight container for culturing flowers is provided with an easy-open lifting cover on the top. The airtight container is provided with a receiving body in the hollow interior. The receiving body is filled with dilatable articles (or water-absorbing articles), vermiculites (fertilizers), and a flower seed. An opening is formed at the bottom of the receiving body, and a bearing is provided beneath the receiving body. The bearing includes a support rod and a support tray, which is provided with holes. The vermiculites or ornamental articles are placed around the bearing.

### BACKGROUND OF THE INVENTION

1. Field of the Invention

The present invention relates to an airtight container for culturing flowers and more particularly, to an airtight container whose interior is provided with a receiving body made of a natural eggshell, preferably, a hen's eggshell or a duck's eggshell, and filled with dilatable articles (or water-absorbing articles), vermiculites and a flower seed, in order to obtain vivid and interesting effects when the plant growing inside the receiving body emerges from the receiving body.

2. Description of the Related Art

Living in a busy and stressful society, people need to relax the state of body and mind. Culturing and planting flowers or seedlings is one of the acceptable leisure activities for most people. Especially when an individual observes the plants growth and blossom, he/she feels satisfaction. Few people have their own gardens to culture and plant flowers or seedlings, and most people culture potted plants. However, it causes an inconvenience and may expose the potted plants to environmental pollution.

Therefore, an airtight container for culturing flowers was designed to overcome the drawbacks of culturing potted plants. Referring to FIG. 1, the prior airtight container 1 for culturing flowers is provided with an easy-open lifting cover 10 on the top and has a hollow interior. Vermiculites 2 for fertilizing, and a flower seed 3 are provided in the hollow interior. The flower seed 3 is provided with characters or patterns 30 formed by a laser on the surface.

Referring to FIG. 2, after the airtight container 2 used for culturing flowers is purchased by a consumer, the lifting cover 10 on the top of the airtight container 1 is lifted to open the airtight container 1, and a suitable volume of water is poured into the airtight container 1 regularly for the plant to grow and blossom. Although it is easy and convenient to culture flowers in the airtight container 1, it lacks interesting aesthetic effect in the process of culturing.

### SUMMARY OF THE INVENTION

Therefore, the present invention is designed to provide an airtight container for culturing flowers that substantially obviates the drawbacks of the prior art.

An objective of the present invention is to provide an airtight container for culturing flowers which includes a receiving body made of a natural eggshell.

Another objective of the present invention is to provide an airtight container for culturing flowers which has vivid, interesting and aesthetic effects when the plants growing in the receiving body emerge therefrom.

Accordingly, an airtight container for culturing flowers in the present invention is provided with an easy-open lifting cover on the top. The airtight container is provided with a receiving body disposed in the hollow interior thereof. The receiving body is filled with dilatable articles (or water-absorbing articles), vermiculites for fertilizing, and a flower seed in the interior. An opening is provided at the bottom of the receiving body, and a bearing is provided beneath the receiving body. The bearing comprises a support rod and a support tray. The support tray has holes formed therein. The vermiculites or ornamental articles (such as a nest, natural rice straws or leaves) are positioned around the bearing.

### BRIEF DESCRIPTION OF THE DRAWINGS

Other features and advantages of the present invention will become apparent in the following detailed description of the preferred embodiments with reference to the accompanying drawings, in which:

FIG. 1 is a front sectional view of a prior art airtight container for culturing flowers;

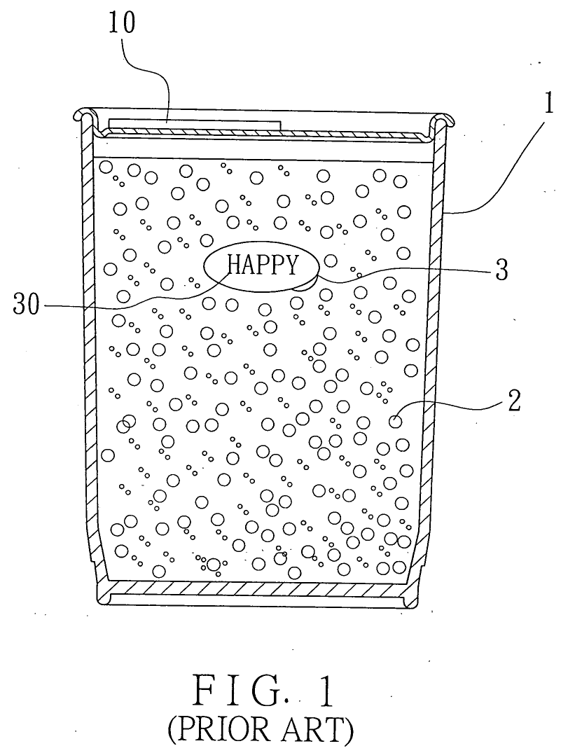

FIG. 2 is a front sectional schematic view of the prior art airtight container showing the plant in blossom;

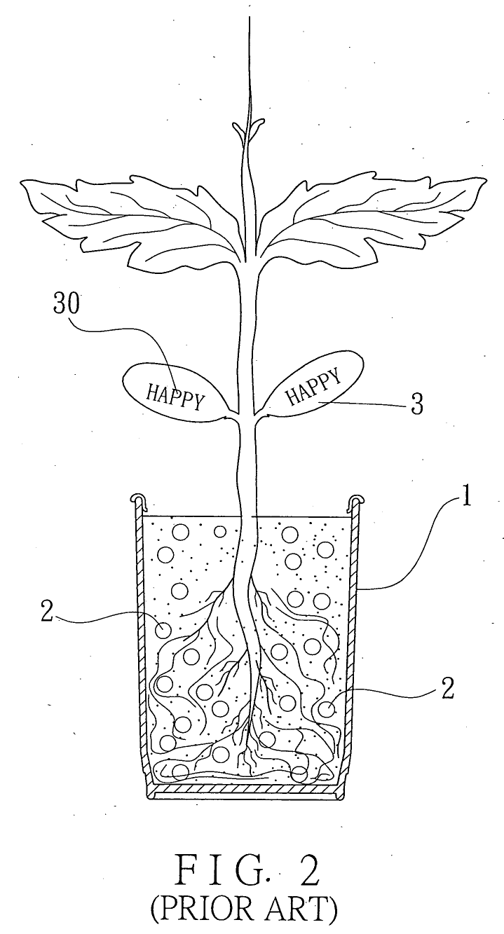

FIG. 3 is a front sectional view of an embodiment of the airtight container for culturing flowers in accordance with the present invention;

FIG. 4 is a front sectional schematic view of an embodiment of the airtight container in accordance with the present invention showing the plant in blossom;

FIG. 5 is a front sectional view of another embodiment of the airtight container for culturing flowers in accordance with the present invention;

FIG. 6 is a front sectional schematic view of another embodiment of the airtight container in accordance with the present invention showing the plant grown to blossom;

FIG. 7 is a front sectional view of a further embodiment of the airtight container for culturing flowers in accordance with the present invention;

FIG. 8 is a front sectional schematic view of a further embodiment of the airtight container in accordance with the present invention showing the plant grown to emerge from the top portion of the receiving body; and,

FIG. 9 is another front sectional schematic view of a further embodiment of the airtight container in accordance with the present invention showing the receiving body broken down into pieces by the grown plant and the dilatable articles.

### DETAILED DESCRIPTION OF THE PREFERRED EMBODIMENTS

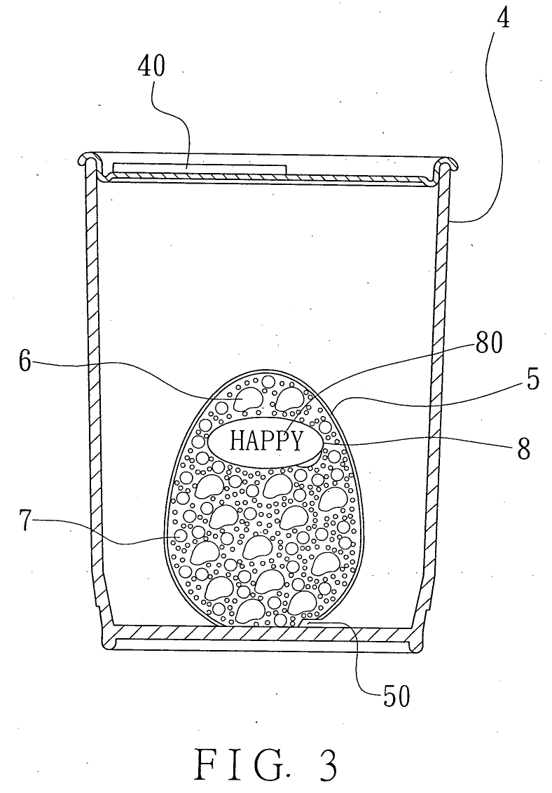

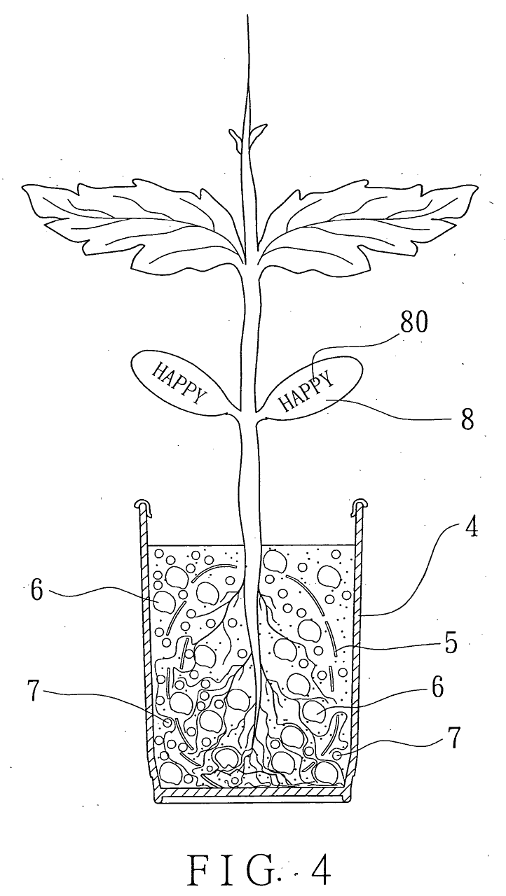

Referring to FIGS. 3 and 4, an embodiment of the airtight container 4 for culturing flowers in the present invention is provided with an easy-open lifting cover 40 on the top. The airtight container 4 is provided with a receiving body 5 disposed in the hollow interior of the container 4. The receiving body 5 is filled with dilatable articles (or water-absorbing articles) 6, vermiculites 7 (fertilizers), and a flower seed having a surface 8 formed by cotyledons of the plant to be grown from the seed. An opening 50 is formed at the bottom of the receiving body 5. The flower seed is provided with characters or patterns 80 made by a laser on the surface 8 thereof. The lifting cover 40 on the top of the airtight container 4 is pulled to open the container 4, and then a suitable volume of water is poured into the airtight container 4. The water is absorbed by the dilatable articles (or water-absorbing articles) 6 inside the receiving body 5. When the dilatable articles (or water-absorbing articles) 6 dilate to a certain volume, the receiving body 5 will break down so that the dilatable articles or water-absorbing articles 6, vermiculites 7 and the flower seed 8 fill up the hollow interior of the airtight container 4.

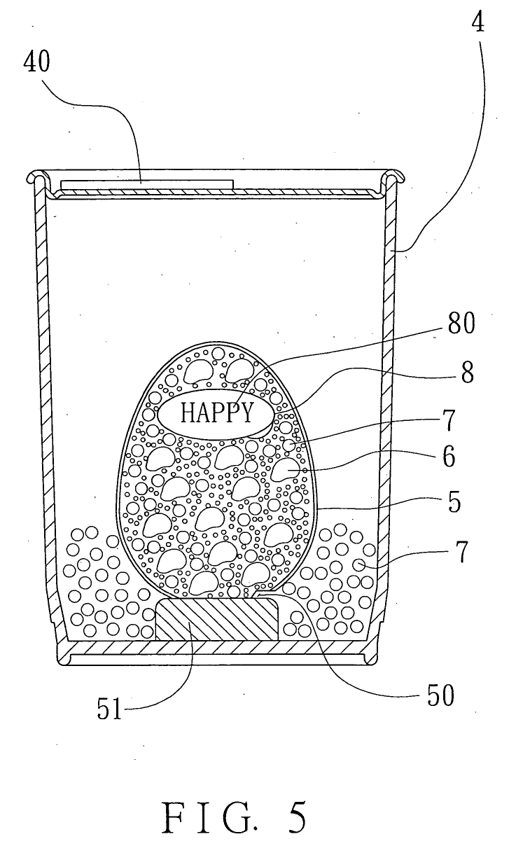

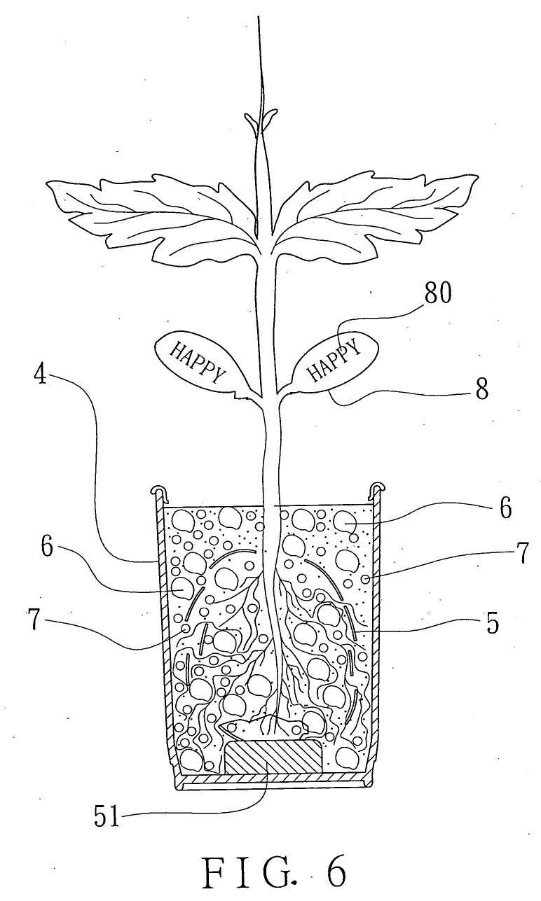

Referring to FIGS. 5 and 6, another embodiment of the airtight container 4 for culturing flowers in the present invention is provided with an easy-open lifting cover 40 on the top. The airtight container 4 is provided with a receiving body 5 disposed in the hollow interior. The receiving body 5 is filled with dilatable articles (or water-absorbing articles) 6, vermiculites 7 for fertilizing, and a flower seed having a surface 8 formed by cotyledons of the plant to grow from the seed. The flower seed is provided with characters or patterns 80 formed by a laser on the surface 8 thereof. An opening 50 is provided at the bottom of the receiving body 5, and a bearing 51 is provided beneath the receiving body 5. The vermiculites 7 (fertilizers) are disposed outside the receiving body 5. The lifting cover 40 on the top of the airtight container 4 is pulled to open the airtight container 4, and a suitable volume of water is poured into the airtight container 4. When the water is absorbed by the dilatable articles (or water-absorbing articles) 6 inside the receiving body 5, the dilatable articles (or water-absorbing) articles 6 dilate to a certain volume, thus causing that the receiving body 5 breaks down, and the dilatable articles (or water-absorbing articles) 6, vermiculites 7 and the flower seed fill up the hollow interior of the container 4.

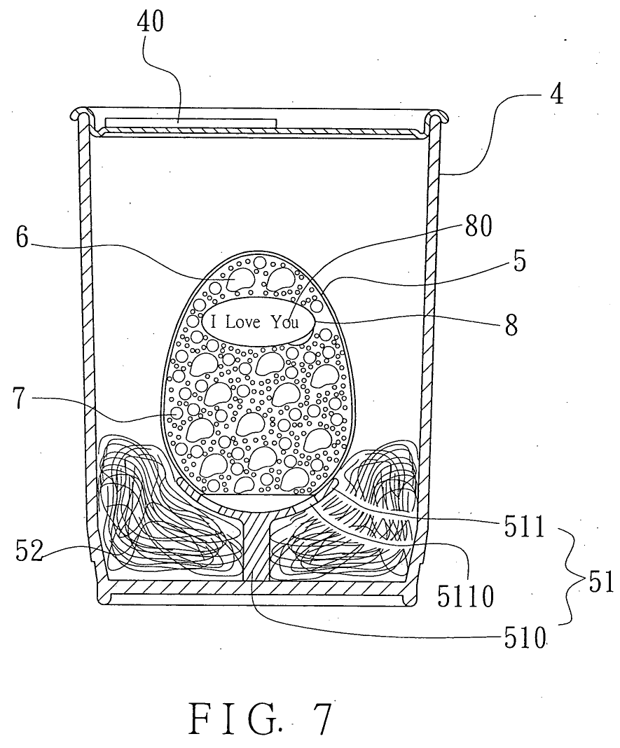

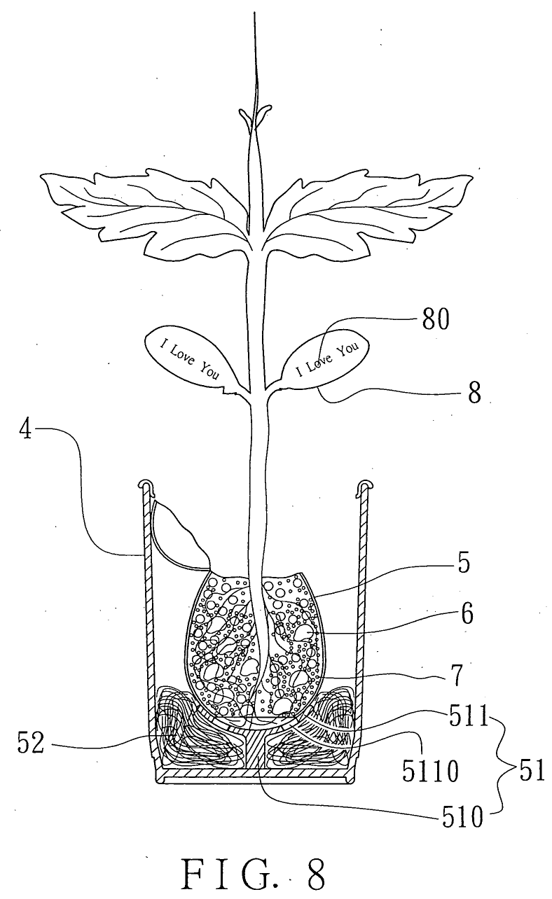

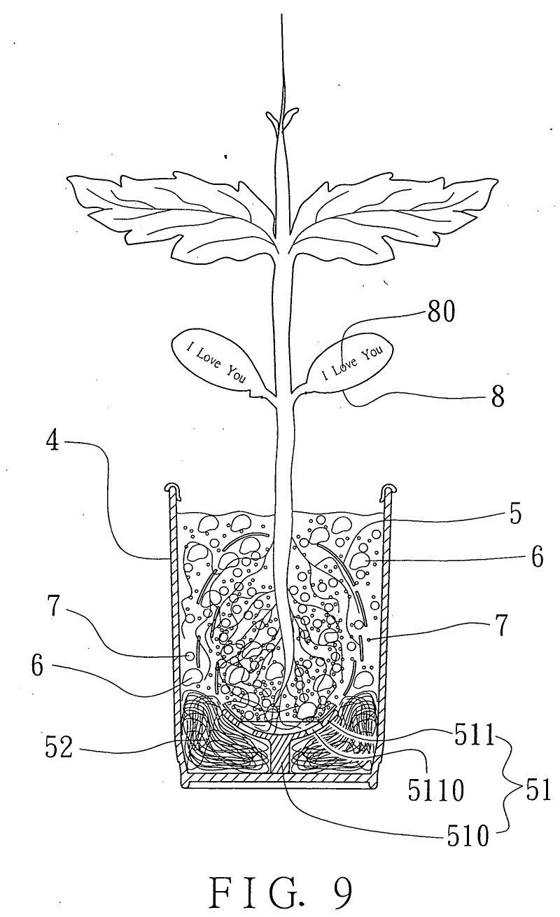

Referring to FIGS. 7, 8 and 9, a further embodiment of the airtight container 4 for culturing flowers in the present invention is provided with an easy-open lifting cover 40 on the top. The airtight container 4 is provided with a receiving body disposed in the hollow interior. The receiving body 5 is filled with dilatable articles (or water-absorbing articles) 6, vermiculites 7 (fertilizers), and a flower seed having a surface 8 formed by cotyledons of the plant to grow. The surface 8 of the flower seed is provided with characters or patterns 80 formed by a laser on the surface 8. An opening 50 is provided at the bottom of the receiving body 5, and a bearing 51 is positioned beneath the receiving body 5. The bearing 51 includes a support rod 510 and a support tray 511. The support tray 511 has holes 5110 formed therein. Ornamental articles 52 (such as a nest, natural rice straws or leaves) are placed around the bearing 51.

While the preferred embodiments of the invention have been described above, it will be recognized and understood that various modifications may be made therein and the appended claims are intended to cover all such modifications which may fall within the spirit and scope of the invention.

1. An airtight container for culturing flowers comprising:
a container having walls defining a hollow interior of said container and a cover attached at the top of said walls to seal said container,
a receiving body disposed in said hollow interior of said container, said receiving body being made from a fragile material, and
dilatable articles, vermiculites, and at least one flower seed disposed in said receiving body, wherein said receiving body breaks down, thus permitting a flower grown from said flower seed to emerge therefrom.

2. (canceled)

3. An airtight container for culturing flowers as recited in claim 1, wherein said receiving body has an opening formed at the bottom of said receiving body.

4. An airtight container for culturing flowers as recited in claim 1, further comprising a bearing positioned beneath said receiving body.

5. An airtight container for culturing flowers as recited in claim 4, wherein water-absorbing articles and vermiculite are disposed around said bearing.

6. An airtight container for culturing flowers as recited in claim 5, wherein said bearing includes a support rod and a support tray, and said support tray including holes formed therein.

7. An airtight container for culturing flowers as recited in claim 6, further including ornamental articles positioned around said bearing.
